(19) United States
(12) Patent Application Publication
(10) Pub. No.: US 2026/0236878 A1
(43) Pub. Date: Aug. 13, 2026

(54) SYSTEM AND METHOD FOR PROVIDING CROWD-BASED LOGISTICS SERVICES FOR ENHANCED ORDER FULFILLMENT

(71) Applicant: ORLANDO MCMASTER, PLANTATION, FL (US)

(72) Inventor: ORLANDO MCMASTER, PLANTATION, FL (US)

(21) Appl. No.: 19/537,475

(22) Filed: Feb. 11, 2026

Related U.S. Application Data
(60) Provisional application No. 63/757,196, filed on Feb. 11, 2025.

(51) Int. Cl. G06Q 10/08; G06Q 10/083; G06Q 10/087

(52) U.S. Cl. CPC G06Q 10/08; G06Q 10/083; G06Q 10/087

(57) ABSTRACT

A method, system and computer program product enable purchasing and transporting items to a recipient via a courier. A processor-executed next flight courier/logistics process determines whether items in a buyer's order request are approved based on established restrictions limiting category, weight, size and/or value of the item(s). Following item/order approval, the NFL process identifies a target store proximate to available couriers and having a fulfillment service capability that aligns with and/or satisfy request parameters. The NFL process selects an individual/courier whose expected travel itinerary enables timely delivery of the order to a buyer/recipient. Following receipt of payment to cover the costs of the items and logistics services, the NFL process initiates purchasing of the item(s) from the target store(s) and arranges for the courier to receive the items. The NFL process triggers payment to the courier for transport and delivery of the items/order to the recipient or designated mailbox.

### PRIORITY

This application claims priority to U.S. Provisional Application No. 63/757,196, filed Feb. 11, 2025, the content of which is incorporated herein by reference.

### BACKGROUND

### 1. Technical Field

The present disclosure relates generally to crowd-based logistics services, and more particularly, to a system and method for providing crowd-based logistics services to support online purchases and enhance order fulfillment.

### 2. Description of the Related Art

Shipping logistics to the Caribbean, South America and other developing countries have long been plagued by a number of significant challenges that not only increase costs but also lead to delays, inefficiencies, and customer frustration. A unique geography, reliance on a limited number of transportation hubs, and logistical infrastructure challenges involving customs and bureaucracy contribute to the complexities of shipping goods to and from developing countries. These problems are felt most acutely in the movement of goods that are either scarce or prohibitively expensive in many developing countries due to the high cost of traditional shipping methods.

One of the most prominent issues is the high cost of shipping. Traditional international shipping, particularly from regions where goods are in abundant supply (such as the United States or Europe), is often prohibitively expensive for both businesses and consumers in developing countries, such as the Caribbean and South America. Shipping rates for both small and large items can be as much as three to four times higher than domestic rates, primarily due to limited shipping routes, high fuel costs, customs duties, and other logistical challenges. These elevated shipping costs place a heavy burden on consumers, businesses, and even local retailers who struggle to meet demand for products that are not readily available in their region.

Another key problem is the unpredictability of shipping schedules. With limited air and sea routes, cargo transportation to developing countries often lacks flexibility and is subject to delays. Ships and planes are frequently rerouted, canceled, or delayed due to weather conditions, port congestion, customs processing, or other unforeseen factors. This results in inconsistent delivery timelines, which can be particularly problematic for businesses requiring timely inventory replenishment or for individuals waiting for urgent goods. Furthermore, shipping times can be unreliable, causing significant inconvenience and frustration for customers who are accustomed to the more predictable shipping timelines in major markets.

The combination of high shipping costs and unreliable schedules has led to widespread frustration of consumers across these regions. Consumers are often faced with long waits for goods to arrive, sometimes weeks or even months beyond the expected delivery date, making them hesitant to place orders. Businesses are forced to either absorb these shipping costs or pass them on to customers, which undermines their ability to offer competitive pricing and create a seamless shopping experience. This frustration is amplified by the fact that many goods that are readily available in other regions of the world are either cost-prohibitive or completely unavailable in these regions, leading to increased demand for alternatives that can bridge this gap.

As a result, there is a pressing need for a more efficient, cost-effective, and reliable shipping solution that can provide quicker delivery times while lowering costs for both businesses and consumers. Traditional logistics solutions are insufficient to meet the growing demands of the markets in these developing countries/regions, particularly when it comes to the transportation of goods that are either expensive or hard to find in the region.

### SUMMARY

The present invention is directed to a method, a system and a computer program product for purchasing items to be transported to a recipient. A processor-executed next flight courier/logistics (NFL) utility configures a computer device to determine whether items in a buyer's order request can be approved, based on established restrictions limiting item category, weight, size and/or value of the item(s). Following item/order approval, the NFL utility identifies a target store proximate to available couriers and having a fulfillment service capability that aligns with and/or can satisfy consumer request parameters. In addition, the NFL utility configures the computing device to select an individual/courier whose expected travel itinerary enables timely delivery of the order to a buyer/recipient. Following receipt of payment to cover the costs of the items and trackable logistics services, the NFL utility configures the computer device to purchase the item(s) from the target store(s) and arrange for the courier to receive the items. The NFL utility configures the computer device to pay the courier for transport and delivery of the items/order to the recipient or designated mailbox at the travel destination.

### BRIEF DESCRIPTION OF THE DRAWINGS

The illustrative embodiments will hereinafter be described in conjunction with the appended drawings provided to illustrate and not to limit the disclosure, where like reference numerals refer to like parts/elements throughout the several views of the drawings. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 illustrates a block diagram representation of an example data processing system within which certain features of the present disclosure can be implemented, according to one or more embodiments;

FIG. 2 illustrates a crowd-based logistics service environment with a networked system of devices for supporting online purchases and enhancing order fulfillment, according to one or more embodiments;

FIGS. 3A, 3B, 3C and 3D present example graphical user interfaces (GUIs) by which a user can interact with an application to initiate online purchases and select a date for the transport and/or receipt of purchased items, according to one or more embodiments;

FIG. 4 presents a flow chart illustrating the process of receiving and approving requests for online purchases, identifying a target vendor store, and selecting an individual courier to transport purchased items to a recipient, according to one or more embodiments;

FIG. 5 presents a flow chart illustrating the process of registering users as buyers and couriers, facilitating online purchases by utilizing shared links to target items, and providing logistics services to transport items to a recipient or a mailbox in a delivery destination, according to one or more embodiments;

FIG. 6 presents a flow chart illustrating the process of executing an order approval procedure, purchasing approved items from a target store, and providing trackable logistics services for approved orders, according to one or more embodiments;

FIG. 7 presents a flow chart illustrating the process of utilizing request parameters to select a target vendor store as well as an individual courier to transport purchased items to a recipient, according to one or more embodiments;

FIG. 8 presents a flow chart illustrating the process of utilizing request parameters to select a target vendor store, an individual courier, and logistics services to facilitate expedited order delivery, according to one or more embodiments;

FIG. 9 presents a flow chart illustrating the process of providing benefits to registered buyers based on the value/volume of purchases, to couriers for providing logistics services and to current users for referring individuals who become active registered members, according to multiple embodiments; and

FIG. 10 presents a flow chart illustrating the process of utilizing a buyer supplied link to target items to initiate an order approval procedure as well as to execute online item purchases, according to one or more embodiments.

### DETAILED DESCRIPTION

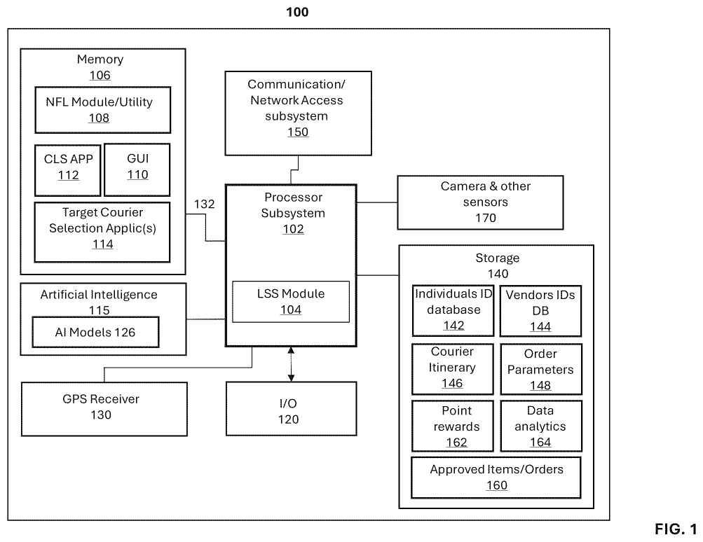

The following detailed description is merely exemplary in nature and is not intended to limit the described embodiments or the application and uses of the described embodiments. As used herein, the word “exemplary” or “illustrative” means serving as an example, instance, or illustration. Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is in part defined by the claims and extended to include logical variations and extensions thereof. For purposes of description herein, the terms “upper”, “lower”, “left”, “rear”, “right”, “front”, “vertical”, “horizontal”, and derivatives thereof shall relate to the orientations presented in FIG. 1. Furthermore, there is no intention to be bound by any expressed or implied theory presented in the preceding technical field, background, brief summary, or the following detailed description. It is also to be understood that the specific devices and processes illustrated in the attached drawings, and described in the following specification, are simply exemplary embodiments of the inventive concepts defined herein and captured within the appended claims. Hence, specific dimensions and other physical characteristics relating to the embodiments disclosed herein are not to be considered as limiting.

As shown throughout the figures, the present disclosure is directed toward providing crowd-based logistics services to support online purchases and enhance order fulfillment. The disclosure provides a crowd-logistics model that leverages airline passengers as an innovative solution to overcome the inherent challenges of traditional shipping. By utilizing commercial airline passengers who are already traveling between cities where goods are readily available and delivery destinations, this model aims to provide a faster, more affordable, and more reliable means of transporting goods to regions in which the goods are not easily accessible or available or where local pricing may prove prohibitive to acquiring the goods. The crowd-logistics platform enables individuals to transport items as part of their personal luggage or carry-on, offering a cost-effective alternative to traditional cargo shipping methods, while also dramatically improving the speed and reliability of deliveries.

The solution provides a much-needed alternative for sourcing goods that are often expensive or unavailable in the destination region/country, reducing dependency on traditional logistics and providing consumers with access to a wider range of products at more affordable prices. This model addresses both the need for cost savings and faster delivery times, offering a scalable, efficient, and innovative approach to logistics in purchasing products from a foreign country, such as the USA, thus requiring delivery via air or sea.

In the following detailed description of exemplary embodiments of the disclosure, specific exemplary embodiments in which the various aspects of the disclosure may be practiced are described in sufficient detail to enable those skilled in the art to practice the invention, and it is to be understood that other embodiments may be utilized and that logical, architectural, programmatic, mechanical, electrical, and other changes may be made without departing from the spirit or scope of the present disclosure. The following detailed description is, therefore, not to be taken in a limiting sense, and the scope of the present disclosure is defined by the appended claims and equivalents thereof. Within the descriptions of the different views of the figures, similar elements can be provided with similar names and reference numerals as those of the previous figure(s). The specific numerals assigned to the elements are provided solely to aid in the description and are not meant to imply any limitations (structural or functional or otherwise) on the described embodiment. It will be appreciated that for simplicity and clarity of illustration, elements illustrated in the figures have not necessarily been drawn to scale. For example, the dimensions of some of the elements are exaggerated relative to other elements.

It is understood that the use of specific component, device and/or parameter names, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

As further described below, implementation of the functional features of the disclosure described herein is provided within processing devices and/or structures and can involve use of a combination of hardware, firmware, as well as several software-level constructs (e.g., program code and/or program instructions and/or pseudo-code) that execute to provide a specific utility for the device or a specific functional logic. The presented figures illustrate both hardware components and software and/or logic components.

Those of ordinary skill in the art will appreciate that the hardware components and basic configurations depicted in the figures may vary. The illustrative components are not intended to be exhaustive, but rather are representative to highlight essential components that are utilized to implement aspects of the described embodiments. For example, other devices/components may be used in addition to or in place of the hardware and/or firmware depicted. The depicted example is not meant to imply architectural or other limitations with respect to the presently described embodiments and/or the general invention. The description of the illustrative embodiments can be read in conjunction with the accompanying figures. Embodiments incorporating teachings of the present disclosure are shown and described with respect to the figures presented herein.

With reference now to the figures, and beginning with FIG. 1, there is depicted a block diagram representation of an example data processing system (DPS), as utilized within one embodiment. DPS may be a server, a personal computer, and/or other types of electronic devices that may generally be considered processing devices or computing systems/devices. As illustrated, DPS 100 comprises at least one processor/controller subsystem 102 connected to system memory 106 via system interlink/bus 132. The processor/controller subsystem 102 executes one or more computer programs/applications and is configured to cause the DPS 100 to provide selection and scheduling of crowd-based logistics services to support online purchases and enhance order fulfillment, according to various aspects of the present disclosure. According to an aspect, a crowd-logistics model leverages commercial airline passengers who are already traveling between cities where goods are readily available and remote delivery destinations to provide a fast, affordable, and reliable means of transporting goods.

In one or more embodiments, DPS 100, which is managed by processor/controller subsystem 102, also includes communication subsystem 150, data storage subsystem 140, Artificial Intelligence (AI) subsystem 118, GPS receiver 130, cameras and other sensors 170, and input/output (I/O) subsystem 120. As shown, processor/controller subsystem 102 includes a Logistics Services Scheduling (LSS) module 104 to support the order request parameter analysis, the vendor's order fulfillment capability analysis, and the courier's itinerary analysis functionality of DPS 100. Processor/controller subsystem 102 executes program code to provide operating functionality of DPS 100. The software and/or firmware modules have varying functionality when their corresponding program code is executed by processor/controller subsystem 102 or secondary processing devices (not explicitly shown) within DPS 100.

As illustrated, DPS 100 includes an I/O subsystem 120. The I/O subsystem includes user interface devices including output devices such as audio output device(s)/speaker, and a display device (not shown). In one or more implementations, the display device includes touch screen functionality enabling display device to function as both an input device and an output device. In addition, I/O subsystem 120 includes input devices including a microphone, a keypad, and/or a mouse.

Processor/controller subsystem 102 is communicatively coupled, via system bus/interlink 132, to device memory 106. In one or more embodiments, processor subsystem 102 is communicatively coupled via system interlink 132 to communication subsystem 150, data storage subsystem 140, and input/output subsystem 120. System interlink 132 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components.

Communication subsystem 150 may be configured to enable DPS 100 to communicate with a plurality of personal computing devices. The communication subsystem may include wired and/or wireless communication devices to facilitate networked communication. Communication subsystem 150 also includes a Network Access Module by which DPS 100 may connect to one or more access/external networks such as the Internet or wide area network (WAN), or an internal network such as an Ethernet via a local area network (LAN), or a Virtual Private Network (VPN).

In addition to the above-described hardware components of DPS 100, various features of the invention are completed/supported via software (or firmware) code or logic stored within memory 106 or other storage and executed by Processor/controller subsystem 102. Thus, for example, illustrated within memory 106 are a number of software/firmware/logic components, including a Target Courier Selection (TCS) application/module 114. Memory 106 includes other applications such as Crowd/Peer Logistics Scheduling (CLS) application 112. According to an aspect, the CLS application 112 is an Internet-based mobile application, which can be made available for download to a user device. In addition, memory 106 comprises a next-flight logistics (NFL) utility 108. Other applications and processing modules are possible and can be provided to support the various features and functions of the disclosure, without limitation. Additionally, all of the Memory 106 further includes an operating system (OS) (not shown), a firmware interface, such as basic input/output system (BIOS) or Uniform Extensible Firmware Interface (UEFI), and firmware (not shown). Memory 106 includes graphical user interfaces (GUIs) 110 (110A-110B) and/or other computer data (not explicitly shown) generated for presentation during processing by the NFL module/utility 108 and/or the TCS application 114.

Data storage subsystem 140 enables further storage and retrieval of data, instructions, and code. In particular, data storage subsystem 140 provides applications, program code, and stored data on nonvolatile storage that is accessible by processor/controller subsystem 102. For example, data storage subsystem 140 can provide, for use by the NFL system 201, the user/individual identification (ID) database 142, vendor information database (DB) 144, courier itinerary database (DB) 146, order parameters 148, point rewards 162, data analytics 164, and approved items/orders 160. In addition, data storage subsystem 140 can provide a selection of program code and applications, such as the CLS application 114 and other related application(s), that can be used to selectively schedule crowd-based logistics/transport services to support online purchases and enhance order fulfillment. These applications can be loaded into device memory 106 for execution by processor subsystem 102.

In actual implementation, the NFL system 201 may be combined with the CLS application 114 to provide a single executable component, collectively providing the various functions of each individual component when the corresponding combined component is activated. For simplicity, the NFL logic/utility 108 is illustrated and described as a stand-alone or separate logic/firmware component, which provides specific functions, as described below.

In one embodiment, DPS 100 communicates with a software deploying server via a network 260 (e.g., the Internet) using communication subsystem/network access module 150. Then, NFL system 201 may be deployed from/on the network, via the software deploying server. With this configuration, the software deploying server or other background server can perform some of the functions associated with the execution of NFL system 201, in one or more embodiments.

The NFL system 201 provides individuals with a mobile App 112 that provides access to an online platform for facilitating online purchase and for selectively scheduling logistics services to enable an individual recipient with access to purchased items based on a target order fulfillment schedule. The individual/user can be presented with audio, visual and/or textual content, via an output device and/or user interface, during various stages of item purchasing and trackable logistics. According to an aspect of the present disclosure, the NFL utility/module 108 enables the individual to provide responses/confirmation/feedback to the presented content via a GUI. According to one or more aspects, the individual/user can be presented with aural content via speakers. The participant may also be presented with image, video and/or textual content via a display device. In addition, the participant may be visually presented with one or more associated selection buttons within the GUI. Using an input device, such as a keypad or a microphone, the participant can provide an input selection as a response to presented content.

Certain of the functions supported and/or provided by the NFL utility/module 108 are implemented as processing logic (or code) executed by processor/controller subsystem 102 and/or other device hardware, which processing logic enables the device to implement/perform those function(s). Among the software code/instructions/logic provided by the NFL module 108, and which are specific to the disclosure, are: (a) logic for receiving a request to purchase from a specified vendor one or more items targeted by an intended buyer/recipient; (b) logic for determining whether the one or more targeted items can be approved for logistics services; (c) logic for selecting a target store based on order fulfillment capability of the vendor/store; (d) logic for selecting an individual courier to transport targeted items based on travel itinerary and logistics capabilities; (e) logic for receiving payment for an approved order as well as for logistics services; (f) logic for purchasing items from a target vendor store; (g) logic for providing items from the vendor to the individual/courier selected to transport items to a destination location; (h) logic for authorizing a third-party to collect from the vendor items for delivery to the selected courier, according to request parameters; (i) logic for receiving, from the courier, notification that the purchased items are loaded for transport to a destination city/airport; (j) logic for providing the buyer with a buyer/recipient-view of logistics service schedule for order transport and delivery; (k) logic for providing courier with a courier-view of logistics service schedule for order transport and delivery; (l) logic for tracking a carrier used by the courier between origination and destination; (m) logic for receiving confirmation that the order is received at a destination mailbox and/or by an intended recipient; (n) logic for adding an order having target items to be respectively purchased from different vendors/stores to a single shopping cart; and (o) logic for paying the courier for logistics services.

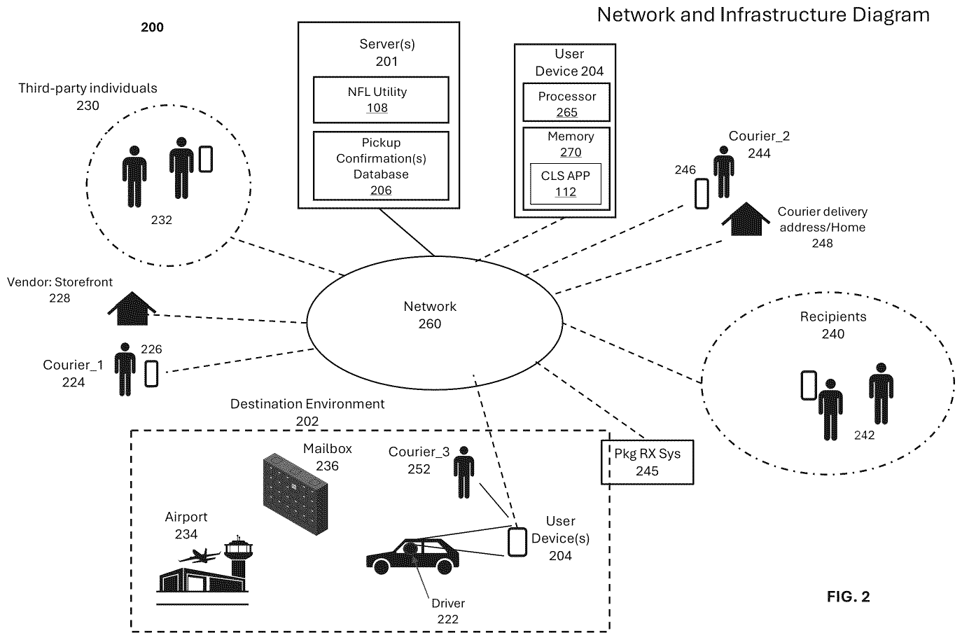

According to the illustrative embodiment, when processor/controller subsystem 102 executes the NFL logic/module 108, DPS 100 initiates a series of functional processes that enable the above functional features as well as additional features/functionality. These features/functionalities are described in greater detail below within the description of FIGS. 2-10.

Additionally, in addition to processor execution of code, aspects of the disclosure involve the use of AI engine 115 and specifically AI models trained to determine several of the processes evaluated herein. In one or more embodiments, processor 102 can utilize AI models 126 to provide AI functionality of processor-integrated AI engine 115. In other embodiments, AI models 126 are directly utilized by AI engine 115. In one or more embodiments, AI model(s) 126 is integrated as a sub-module within NFL module 108 and is trained to support the AI features of NFL module 108. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data. An operating system may include or be augmented by a device AI operating system (OS) that can include native support for AI-specific hardware such as Neural Processing Units (NPUs) or Tensor Processing Units (TPUs) to optimize performance for AI tasks such as machine learning inference and training.

Those of ordinary skill in the art will appreciate that the hardware components and basic configuration depicted in FIG. 1 may vary. The illustrative components within DPS 100 are not intended to be exhaustive, but rather are representative to highlight essential components that are utilized to implement the present disclosure. For example, other devices/components may be used in addition to or in place of the hardware depicted. The depicted example is not meant to imply architectural or other limitations with respect to the presently described embodiments and/or the general disclosure.

Referring now to FIG. 2, there is presented a NFL execution environment 200 that includes or provides a networked system of devices for supporting online purchases and selectively scheduling and providing crowd-based logistics services to transport ordered items to a destination location 202, which can be an airport, according to one or more embodiments of the disclosure. The networked system of devices includes a number of computing/electronic devices. These computing devices, which can be similarly configured to DPS 100 (FIG. 1), include server 201, software deploying server (not explicitly shown), local data aggregation server/DPS (not explicitly shown), user/individual device(s) 204, and remote user/individual device(s) 214. The various computing devices are connected by a network 260. The network 260 can be any of the various networks, including a LAN or a WAN, such as the Internet, described in FIG. 1. Server 201 includes a processor 202 and memory with NFL module/utility 108 stored thereon. Server 201 also includes or is communicatively connected to vendors IDs database (DB) 144, which can be stored on an internal storage component of server 201 or accessible via network or direct cable link to server 201. Sever 201 can be similarly configured and operate as DPS 100 (FIG. 1). For purposes of the description, the processes provided by execution of NFL module/utility 108 by processor 202 within server 201 are described as processes performed by NFL system 201. It is appreciated that the actual processing is provided by execution of NFL module/utility 108 and other applicable program code by one or more processors (102 and/or 202) within server 201/DPS 100.

Other processes described herein are completed by/on the user device 204/244. As illustrated, user device 204/244 comprises processor 265 and memory 270 which further includes CLS App 112, which is executable by processor 265 to configure the processor 265 to perform or trigger performance of various aspects of the user device processes described herein. In some embodiments, CLS App 112 can be downloaded from the software deploying server, such as Google Play Store or Reddit (™). Remote user/courier device 244 are the same as or similar to user devices 204.

Also illustrated in the NFL execution environment 200 is a destination environment/region 202 in which multiple individuals including a driver 222 and a courier_3 252 are located. In addition, destination airport 234 and destination mailbox 236 are included within the destination environment 202. Destination environment 202 can include one or more order/package receiving system 245 configured to facilitate trackable logistics services in a destination region/location. The NFL execution environment 200 can also include a separate last mile delivery environment/region which further includes a recipient's home/office location and associated user devices 204.

In addition, environment 202 includes vendor/store 228 and a courier delivery location or home address 248. Also shown within environment 202 are a number of individuals including courier_1 224, courier_2 244, third-party individuals 230, and recipients 240.

According to one or more aspects, the NFL execution environment 200 includes a store 228 which is owned, managed and/or operated by a specific brand, such as Walmart or Macy's. The brand may operate stores/storefronts in many different locations, cities, states and/or countries. Thus, the NFL module 108 can source a target item from any of multiple stores operated by a same brand for an individual wanting to purchase an item from a particular brand of store. According to another aspect, the NFL module 108 can source a target item from any store operated by any of multiple brands for an individual that simply wants to purchase the item regardless of retailer/vendor brand.

According to one or more aspects, the NFL module 108 establishes a number of restrictions, which can include weight limits, maximum product size/dimensions, threshold values and/or type/category restrictions. The NFL module 108 utilizes the established restrictions to determine whether a product can be approved for transportation using crowd-based logistics services arranged via the CLS App 112. According to an aspect, the NFL module 108 can reject an order for one or more violations of the established restrictions. According to another aspect, the NFL module 108 may split a first larger order (i.e., an order that includes multiple items) into multiple sub-orders to allow the items included in the first order to be identified as sub-orders that can be approved for transportation by respective couriers.

In order to satisfy order/request parameters, the NFL module 108 selects and/or uses resources/services and associated aspects, which include one or more of the following: a vendor/brand; a store/storefront; a courier; courier rating; value of the item to be transported; an intermediary/third-party logistics service or service type; an order purchasing city/location; a departure airport; and a destination airport. Furthermore, the NFL module 108 makes the one or more selections based on a number of goals/factors, which can include one or more of the following: to increase/maximize the number of different orders that can be fulfilled; to optimize/increase the speed at which orders can be fulfilled; to minimize the costs to the buyer; to efficiently and effectively utilize the number of individuals/couriers available to transport items; to efficiently and effectively utilize the amount of space available to transport items; and to enhance the quality of service. According to one or more aspects, the NFL module 108 may select vendors, couriers, stores and/or logistics services based on respective priorities of the factors controlling/impacting the selection of resources/services, etc. According to one or more aspects, the NFL module 108 utilizes artificial intelligence technology to optimally determine the priorities of the one or more factors and to optimally select the resources/services and associated aspects which can be used to satisfy order parameters. The AI functions further implement learning strategies to optimize the delivery of future orders including selection of specific couriers based on the available date received from each of the processes and completed shipments and user feedback relative to those shipments.

According to one or more aspects, the NFL module 108 determines whether items can be expected to be sourced from different vendors/stores. Thus, based on this determination, the NFL module 108 may identify the order as a multi-vendor order. The NFL module 108 can also determine whether the order should be consolidated as a single order or transported by different individuals as associated orders/sub-orders.

According to one or more aspects, an order may comprise a single item obtainable from a single vendor. According to another aspect, an order may comprise multiple items obtainable using different vendors. The NFL module 108 may enable buyers to place such items in a single virtual shopping cart. Furthermore, the NFL module 108 may be configured to track multiple different item routes and logistics services to provide ordered items to the courier(s).

According to one or more aspects, the NFL module 108 can identify one or more types of selectable logistics services/resources that can be expected to provide a higher likelihood of meeting the time constraints associated with the requested delivery time schedule.

According to one or more aspects, the NFL module 108 can select a first selectable logistics service/resource as a better option to a second logistics service/resource in order to increase the likelihood that one or more request parameters can be properly fulfilled.

According to one or more aspects, the NFL module 108 can identify a combination of one or more logistics services/resources that provide a higher likelihood that one or more request parameters can be properly fulfilled.

According to an aspect, the NFL module 108 selects the combination of logistics services/resources that collectively align to achieve a specific high probability that one or more request parameters can be fulfilled.

According to one or more aspects, the NFL module 108 enables an individual/buyer to create shopper/buyer profiles/preferences. In addition, the NFL module 108 enables an individual/buyer to create wish-lists and/or to provide a list of expected future purchases and associated schedules for such purchases. According to an aspect, the NFL module 108 enables an individual/courier to create travel profiles, which may include indications of desired/expected future travel destinations and associated schedules. According to one or more aspects, the NFL module 108 is configured to serve individuals advertising content based on established profiles. The NFL module 108 is configured to incentivize individuals to create profiles and wish-lists, and to provide anticipated schedules for making purchases and/or traveling. Furthermore, the NFL module 108 is configured to reward participating individuals (e.g., buyers and/or couriers) based on how closely the anticipated schedule matches the actual schedule.

According to one or more aspects, the NFL module 108 is configured to provide a buyer with specific/special packaging and handling services. According to one or more related aspects, the NFL module 108 may request that an entity/individual such as a vendor or courier prepare and package items according to specified transport requirements, security requirements, and/or condition/integrity preservation requirements. According to an aspect, the NFL module 108 is configured to provide status updates of packages/items using sensor-based tracking of internal conditions such as temperature, pressure and/or moisture.

According to one or more aspects, the NFL module 108 is configured to enable buyers and recipients to keep their purchasing habits private and/or to receive packages anonymously. The NFL module 108 is configured to enable one or more individuals to participate in providing logistics services without having a buyer's/recipient's identity revealed to the one or more individuals. Similarly, the NFL module 108 is configured to enable one or more couriers to anonymously provide logistics services by which the identity of the courier is not revealed to the buyer, recipient, and/or other individuals providing logistics services to facilitate order fulfillment. According to an implementation, the NFL module 108 can use aliases, codes, or tags to provide anonymity while maintaining package trackability.

According to one or more aspects, the NFL module 108 is configured to promote, advertise and/or recommend purchasable items and vacation/trips to buyers/recipients and/or couriers, respectively. According to a related aspect, the NFL module 108 is configured to enable individuals to view promotional item/trip pages by presenting each page to the individual, receiving from the individual an interactive response indicative of a level of interest in the item/trip and processing the response and/or presenting the next promotional page to the individual based on the response. According to an aspect, the NFL module 108 allows individuals using an application to quickly browse through pages/photos of potentially desirable items/trips with a simple interactive gesture such as a swipe gesture. The interactive feature simplifies the decision-making process, allowing users to quickly assess whether they're interested in purchasing an item or trip/vacation based on the presented promotional content, where the option to initiate a purchase can be selected by an individual using a specified gesture. According to an implementation, the NFL module 108 can include in a promotional item page images and a description for a pre-approved item, the costs associated with purchasing and transporting the item, a likely date of arrival if purchased on a particular day, an option to initiate purchase, an option to add to a favorites list for a potential future purchase, etc. According to an implementation, the NFL module 108 can include, in a promotional vacation/trip page, images and a description for a trip or vacation in which the individual agrees to operate as a courier for one or more of an approximate payment, travel discounts/deals, hotel discounts/deals, restaurant discounts/deals, car rental discounts deals, and/or deals/discounts of tours. Furthermore, the individual may be presented with itinerary options, an option to initiate purchase, an option to add to a favorites list for a potential future purchase, etc.

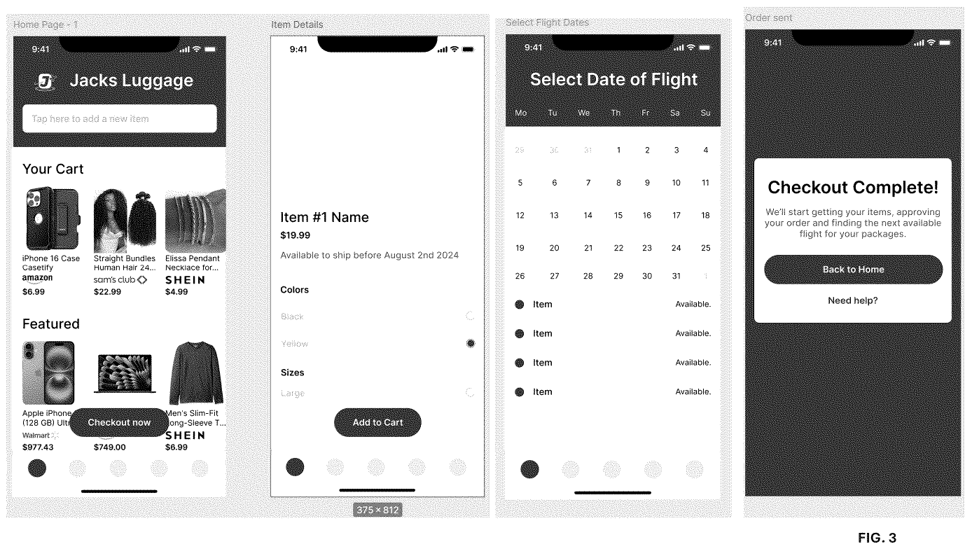

FIGS. 3A, 3B, 3C and 3D present example graphical user interfaces (GUIs) by which a user can interact with an application to initiate online purchases and select a date for the transport and/or receipt of purchased items, according to one or more embodiments.

FIG. 3A provides an example GUI for a shopping cart showing images of items targeted for purchase by a user, the items being sold by various vendors. The example items include a protective iPhone case costing $6.99 and an iPhone costing $977.43. In order to add items to the cart, the user identifies items he wishes to purchase and provides via the CLS app 112 URL links for the items. Using the URL links, the NFL utility 108 retrieves item information which can include attribute options, such as size, weight and/or color of the item. The NFL utility 108 presents the retrieved options to the user to allow the user to select via the CLS app 112 the desired attributes for the item and then adds the item to the cart, as shown in FIG. 3B. The user indicates that his order is complete by pressing/activating the checkout button in FIG. 3A.

The user selects a preferred/target date for the purchased/available order/items to be transported to a destination airport/city, as shown in FIG. 3C. According to an implementation, the CLS app 112 could provide a pop-up calendar with black-out dates and periods, and earliest available delivery dates. For example, a blackout day may be displayed if no courier is available for that day. Furthermore, the calendar may be used to indicate availability of various services including an expedited “EXPRESS” service option or special “High-end COURIER handling” via selectable service dates in the calendar. FIG. 3D indicates a GUI indicating that the user has completed the order request. The NFL utility 108 determines whether the process can be approved and initiates a process to purchase the approved items from one or more target vendor(s).

Following the user's selection of attribute options and/or initiation of the checkout procedure, the NFL utility 108 determines whether the item can be approved for transportation using the crowd-based logistics services. For example, the NFL utility 108 may determine whether the item can be approved for logistics services based on established size, type/category and/or weight restrictions. According to one or more aspects, the NFL utility 108 determines whether the item can be approved for transportation using the crowd-based logistics services even if there are no attribute options to select. Additionally, the NFL utility 108 identifies a target individual courier to transport the order to the intended recipient.

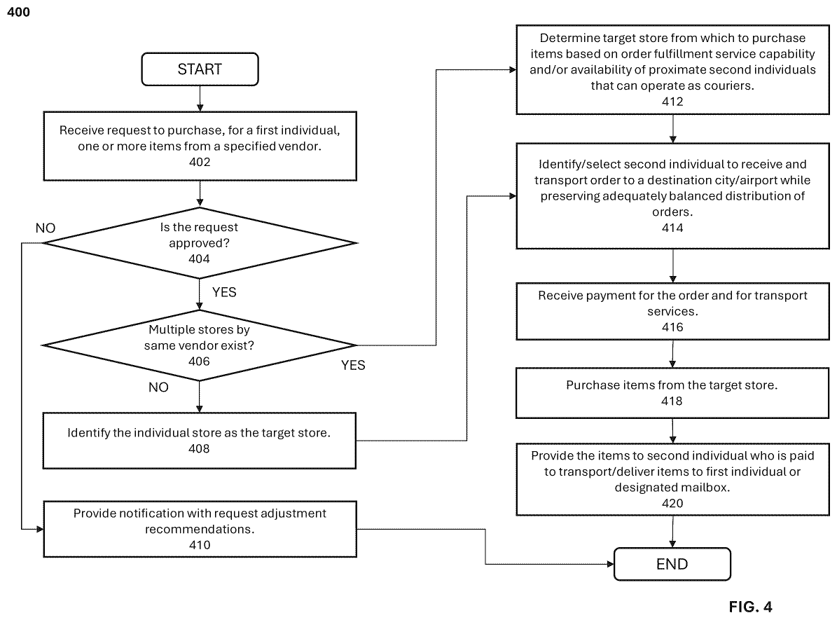

FIG. 4 presents a flow chart illustrating the process of receiving and approving requests for online purchases, identifying a target vendor store and selecting an individual courier to transport purchased items to a recipient, according to one or more embodiments.

The process of FIG. 4 begins at the initiator/start block and proceeds to block 402, at which the NFL module 108 receives a request to purchase, for a first individual/purchaser, one or more items from a specified vendor. At decision block 404, the NFL module 108 determines whether the request can be approved, based on a category and/or attributes of one or more target items. If the NFL module 108 determines that the request cannot be approved, the NFL module 108 provides the user with a notification that the order cannot be approved and provides the user with adjustment recommendations for the requested order, as shown at block 410. However, if the NFL module 108 determines that the request can be approved, the NFL module 108 proceeds to decision block 406 at which the NFL module 108 determines whether there are multiple stores being managed or operated by the same vendor/brand. If the NFL module 108 determines that there is only a single store being operated by the vendor/brand, the NFL module 108 identifies the individual store as the target store, as shown at block 408.

If at decision block 406 the NFL module 108 determines that there are multiple stores being managed or operated by the same vendor/brand, the NFL module 108 selectively determines/identifies the target store from which to purchase items based on order fulfillment service capability and/or availability of proximate second individuals that can operate as couriers, as shown at block 412.

At block 414, the NFL module 108 identifies/selects the second individual to receive and transport the ordered items to a destination city/airport while ensuring that the distribution of orders among couriers is adequately balanced over a specified period of time.

At block 416, the NFL module 108 receives payment for the order and for logistics/transport services. At block 418, the NFL module 108 initiates the processes to purchase the items from the target store. At block 420, the NFL module 108 identifies the second individual who is paid to transport/deliver items to the first individual or designated mailbox and provides/supplies the items to the second individual. The process proceeds to the end block.

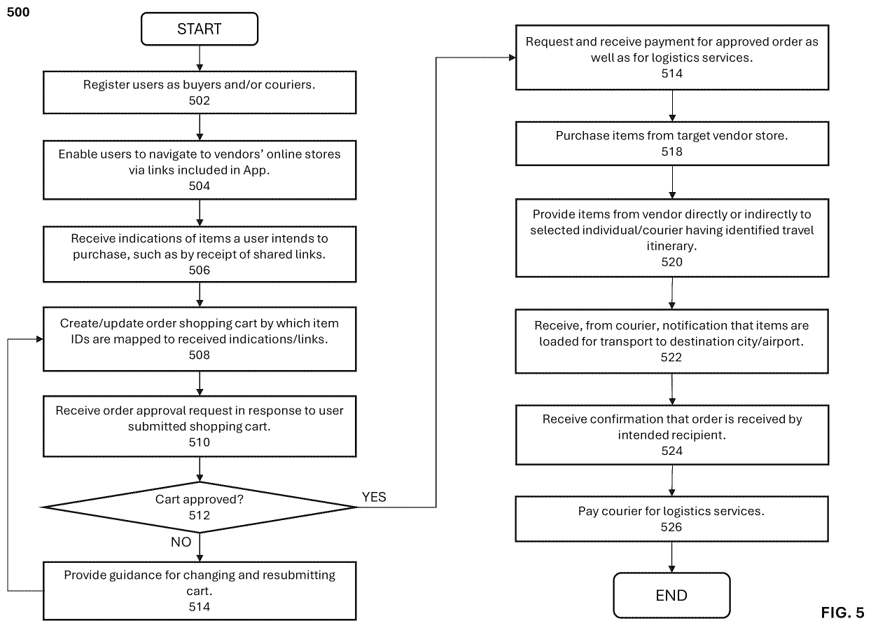

FIG. 5 presents a flow chart illustrating the process of registering users as buyers and couriers, facilitating online purchases by utilizing shared links to target items, and providing logistics services to transport items to a recipient or a mailbox in a delivery destination, according to one or more embodiments.

The process of FIG. 5 begins at the initiator/start block and proceeds to block 502, at which the NFL module 108 registers users as buyers and/or couriers, respectively. At block 504, the NFL module 108 enables users to navigate to identified vendors'online stores via links included in the CLS App 112. Alternatively, the user can externally (i.e., outside of the app) navigate to a vendor's site to identify target items and copy URL links/indications to target items, which links can be subsequently provided to the CLS app112. The NFL module 108 receives indications of items a user intends to purchase, as shown at block 506. According to an implementation, the NFL module 108 receives the indications via shared links provided by the CLS application 112.

At block 508, the NFL module 108 creates/updates an order shopping cart by which item IDs are mapped to received indications/links such as URLs. At block 510, the NFL module 108 receives an order approval request as a result of user submission of the shopping cart. At decision block 512, the NFL module 108 determines whether the order request can be approved, based on the items in the shopping cart. If the NFL module 108 determines that the request cannot be approved, the NFL module 108 provides the user with guidance or adjustment recommendations for changing and resubmitting the cart, as shown at block 514. However, if the NFL module 108 determines that the request can be approved, the NFL module 108 proceeds to block 514, at which the NFL module 108 requests and receives payment for the cost of purchasing items included within the requested order as well as for logistics services.

At block 518, the NFL module 108 triggers processes that result in the purchase of the items from one or more target vendor stores. At block 520, the NFL module 108 provides items from the vendor directly or indirectly to a selected individual/courier having an identified travel itinerary that aligns with the delivery requirements of the purchaser. The NFL module 108 receives, from the courier, notification that the courier has boarded the flight and/or that the items are loaded for transport in the courier's luggage or bags to the destination city/airport, as shown at block 522. According to an aspect, the NFL module 108 enables the carrier to be tracked by the buyer/recipient. The NFL module 108 receives confirmation that the order is received by the intended recipient, as shown at block 524. At block 526, the NFL module 108 provides payment of agreed-to compensation to the courier for providing the logistics services. The process proceeds to the end block.

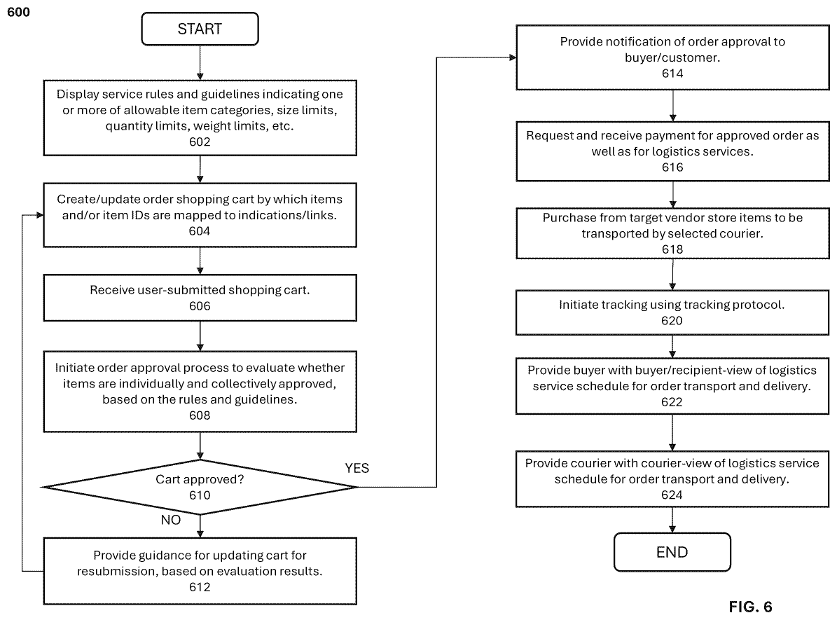

FIG. 6 presents a flow chart illustrating the process of executing an order approval procedure, purchasing approved items from a target store, and providing trackable logistics services for approved orders, according to one or more embodiments.

The process of FIG. 6 begins at the initiator/start block and proceeds to block 602, at which the NFL module 108 displays service rules and guidelines indicating one or more of allowable item categories, size limits, quantity limits, weight limits, etc. At block 604, the NFL module 108 creates/updates order shopping cart by which items and/or item IDs are mapped to indications/links such as URLs.

The NFL module 108 receives a user-submitted shopping cart, as shown at block 606. According to an aspect, the NFL module 108 receives the user-submitted shopping cart in response to the checkout process being initiated by the user. The NFL module 108 initiates an order approval process to evaluate whether items are individually and collectively approved, based on the rules and guidelines, as shown at block 608. At decision block 610, the NFL module 108 determines whether the order and corresponding shopping cart can be approved to enable the items to be transported using crowd-based logistics services. If any of the items are not approved, the NFL module 108 provides guidance for updating the cart for resubmission, based on evaluation results, as shown at block 612. If all items are approved, the NFL module 108 provides a notification of order approval to the buyer/customer, as shown at block 614.

At block 616, the NFL module 108 requests and receives payment for approved order as well as for logistics services. At block 618, the NFL module 108 purchases, from the target vendor store, items to be transported by selected courier.

The NFL module 108 initiates tracking using an established tracking protocol, as shown at block 620. The tracking protocol may include various options for tracking at different points in the order fulfillment process. According to an aspect, individuals such as couriers/intermediary drivers, etc. are expected and/or incentivized to give updates on receipt of goods, loading of goods, delays, mailbox drop-off, delivery, etc. These individuals may be reminded/prompted to provide status updates based on expected schedule information.

At block 622, the NFL module 108 provides the buyer with a buyer/recipient-view of the logistics service schedule for order transport and delivery. At block 624, the NFL module 108 provides the courier with a courier-view of the logistics service schedule for order transport and delivery. The process proceeds to the end block.

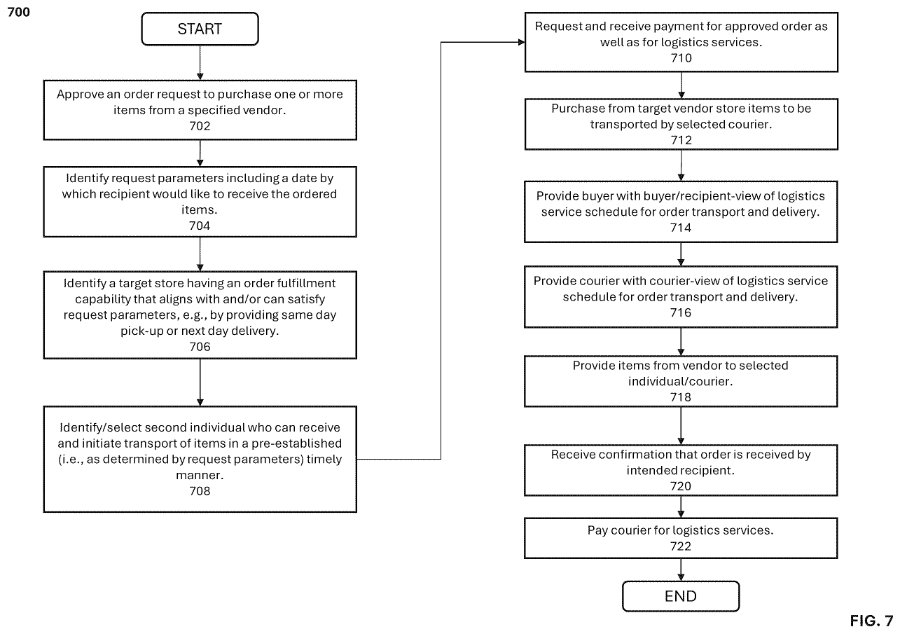

FIG. 7 presents a flow chart illustrating the process of utilizing request parameters to select a target vendor store as well as an individual courier to transport purchased items to a recipient, according to one or more embodiments.

The process of FIG. 7 begins at the initiator/start block and proceeds to block 702, at which the NFL module 108 approves an order request to purchase one or more items from a specified vendor/brand. At block 704, the NFL module 108 identifies request/order parameters including delivery logistics and schedule specifications which further include a date by which recipient would like to receive the ordered items. At block 706, the NFL module 108 identifies a target store that optimally meets relevant order parameters such as schedule specifications, according to the vendor's order fulfillment capability. According to an aspect, the NFL module 108 identifies a target store having an order fulfillment capability that aligns with and/or can satisfy request parameters, e.g., by providing same day pick-up or next day delivery. According to an implementation, the NFL module 108 and/or target store offers/supports various selected order fulfillment service tiers including one or more of Tier 1 (same day pickup), Tier 2 (same day pick-up and 3^{rd} party same day or next day drop-off), Tier 3 (third-party in-store shopping and same day or next day drop-off), Tier 4 (next day pickup and/or 3^{rd} party next day drop-off) and Tier 5 (beyond next day pickup and/or beyond 3^{rd} party next day drop-off).

At block 708, the NFL module 108 identifies/selects, as the optimal courier, a second individual who can receive and initiate transport of items in a pre-established timely manner (i.e., as determined by request parameters). According to one or more aspects, the NFL module 108 identifies an optimal courier based on one or more of a requested order delivery date, courier logistics capabilities, and the provided/known travel itinerary of the courier. For example, after a first time at which items are available for pickup or delivery, an individual courier is expected to receive the items prior to a second time, package/repackage/pack and transport the item to a departure airport and board the carrier with the items and/or place the items in his luggage to load the items on the carrier (airplane/transportation) leaving to destination city/airport, using a scheduled departure/third time. For example, the courier may be expected to receive items the same day order is made available for pick-up and, by the next day, initiate travel and transportation of items to the delivery destination.

The NFL module 108 requests and receives payment for the approved order as well as for logistics services, as shown at block 710. The NFL module 108 initiates purchases from the target vendor store items to be transported by the selected courier, as shown at block 712. At block 714, the NFL module 108 provides the buyer with a buyer/recipient-view of logistics service schedule for order transport and delivery. At block 716, the NFL module 108 provides the courier with a courier-view of logistics service schedule for order transport and delivery.

The NFL module 108 provides items from the vendor to a selected individual/courier having an identified travel itinerary, according to courier logistics capabilities, as shown at block 718. According to an aspect, th NFL module 108 provides tracking associated with the various stages of order fulfillment. The NFL module 108 receives confirmation that the order is received by the intended recipient, according to the order delivery logistics, as shown at block 720. At block 722, the NFL module 108 initiates electronic payment or other form of financial or non-financial compensation to the courier for providing the logistics services. The process proceeds to the end block.

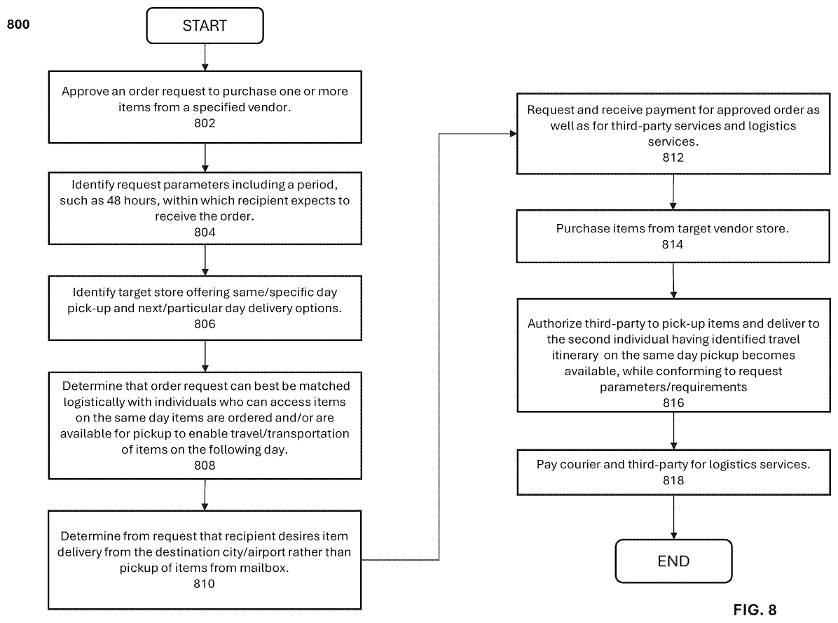

FIG. 8 presents a flow chart illustrating the process of utilizing request parameters to select a target vendor store, an individual courier, and logistics services to facilitate expedited order delivery, according to one or more embodiments.

The process of FIG. 8 begins at the initiator/start block and proceeds to block 802, at which the NFL module 108 approves an order request to purchase one or more items from one or more specified vendor(s). At block 804, the NFL module 108 identifies request parameters including a period, such as 48 hours, within which recipient expects to receive the order. At block 806, the NFL module 108 identifies a target store that offers same/expedited/specific day pick-up and next/particular day delivery options. The NFL module 108 determines that request can best be matched logistically with individuals/couriers who are able to access items on the same day the items are ordered and/or are available for pickup to enable travel/transportation of items on the following day or a later day, as shown at block 808. According to one or more aspects, the NFL module 108 may determine that the courier can access the items on a particular day based on access to logistics service(s) involving one or more of the following: item pick-up by the courier; item delivery to the courier; item pick-up and delivery to the courier using a third-party service. In an example scenario, same day access to the order by a courier may be preferred. However, the available courier may not be able to perform the order pickup. In this case, a third-party service could be deployed to execute order pick-up and delivery of the order to the courier. Furthermore, if the store cannot have the order ready within a threshold period of time or number of days, a third-party service such as Insta-cart service can be used to shop in-store and/or deliver the items to a courier to satisfy logistics scheduling requirements. For example, if a same/next day order fulfillment is requested, Insta-cart staff can shop and deliver items to the courier for same or next day delivery to the destination city/airport. The Insta-Cart service can be ordered by the administrator of CLS app 112 via an API. The cost for this additional logistics to ensure timely delivery is then factored into the delivery/administrative costs charged to the purchaser for using the service.

The NFL module 108 determines from the request information that the recipient desires item delivery to his designated address from the destination city/airport rather than item pickup from a mailbox, as shown at block 810. The NFL module 108 requests and receives payment for approved order as well as for third-party/intermediary services and logistics services, as shown at block 812. The NFL module 108 purchases items from the target vendor store, as shown at block 814.

At block 816, the NFL module 108 authorizes a third-party to pick-up items and deliver to the second individual/courier having the identified travel itinerary. The third-party can pickup and deliver items on the same day pickup becomes available, while conforming to request parameters/requirements. At block 818, the NFL module 108 pays the courier and the third-party for logistics services. The process proceeds to the end block.

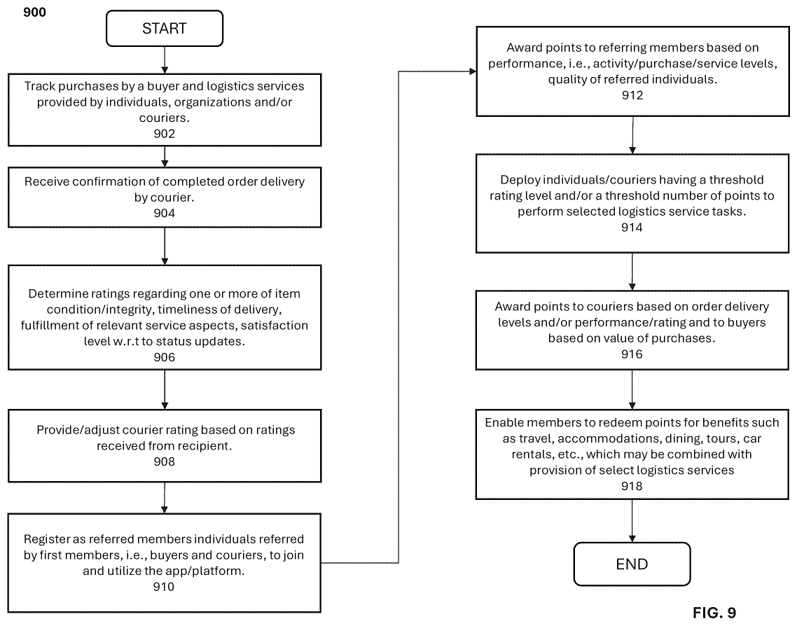

FIG. 9 presents a flow chart illustrating the process of providing benefits to registered buyers based on the value/volume of purchases, to couriers for providing logistics services, and to current users for referring individuals who become active registered members, according to one or more embodiments.

The process of FIG. 9 begins at the initiator/start block and proceeds to block 902, at which the NFL module 108 tracks purchases made by a buyer and logistics services provided by identified individuals, organizations and/or couriers. The NFL module 108 receives confirmation of a completed order delivery by the courier, as shown at block 904. The NFL module 108 determines ratings regarding one or more of item condition/integrity, timeliness of delivery, fulfillment of relevant service aspects, satisfaction level with respect to an individual's issuing of status updates, etc., as shown at block 906. The NFL module 108 provides/adjusts a courier rating based on ratings received from recipient, as shown at block 908. At block 910, the NFL module 108 registers as referred members individuals referred by first members, i.e., buyers and couriers, to join and utilize the app/platform. At block 912, the NFL module 108 awards points to referring members based on performance, i.e., activity/purchase/service levels, quality/performance of referred individuals.

The NFL module 108 deploys individuals/couriers having a threshold rating level and/or a threshold number of points to perform selected logistics service tasks, as shown at block 914.

The NFL module 108 awards points to couriers based on order delivery levels and/or performance/rating and to buyers based on value of purchases, as shown at block 916. For example, the NFL module 108 awards points to buyers/members based on dollar volume of purchases since joining as a member or over a measured period (e.g., last 4 months). At block 918, the NFL module 108 enables members to redeem points for benefits such as travel, accommodations, dining, tours, car rentals, etc., which may be combined with provision of select logistics services. For example, a courier may receive special benefits (e.g., a free hotel night) while traveling and performing select logistics services. The process proceeds to the end block.

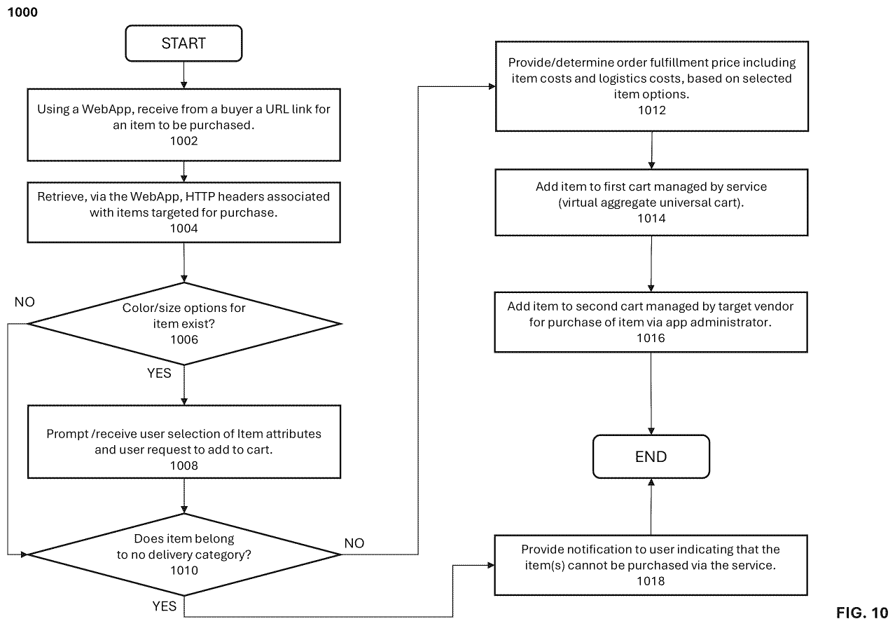

FIG. 10 presents a flow chart illustrating the process of utilizing a buyer supplied link to target items to initiate an order approval procedure as well as to execute online item purchases, according to one or more embodiments.

The process of FIG. 10 begins at the initiator/start block and proceeds to block 1002, at which the NFL module 108 receives, via a WebApp from a buyer, a URL link for an item to be purchased. At block 1004, the NFL module 108 retrieves, via the WebApp, HTTP headers associated with items targeted for purchase. According to an implementation, the HTTP headers are retrieved using XmlHttpRequest( ). At decision block 1006, the NFL module determines whether selectable attribute options such as color/size options for the item exist. If the NFL module 108 determines that selectable attribute options exist, the NFL module 108 triggers the user to select the item attributes and, as a result, receives the user's selection of item attributes and the user's request to add the item to the shopping cart, as shown at block 1008. However, if the NFL module 108 determines that selectable attribute options do not exist, the NFL module 108 proceeds to block 1010.

At decision block 1010, the NFL module 108 determines, using the selected attribute options, whether the item is identifiable as a type of item that belongs to a no delivery category. If the NFL module 108 determines that the item does not belong to a no delivery category, the NFL module 108 provides the user with a notification indicating that the item(s) cannot be purchased and supported via the crowd-based logistics service platform, as shown at block 1018. However, if the NFL module 108 determines that the item does not belong to a no delivery category, the NFL module 108 provides/determines the price for order fulfillment including item costs and logistics costs, based on selected item options, as shown at block1012.

At block 1014, the NFL module 108 adds the item to a first cart which is managed by CLS App 112 (e.g., a virtual aggregate universal cart). At block 1016, the NFL module 108 adds the item to a second cart which is managed by the vendor, enabling purchase of item(s) via the app administrator. The process proceeds to the end block.

As described herein, a method, a system and a computer program product for purchasing items to be transported to a recipient is provided. A processor executed next flight courier/logistics utility determines whether items in a buyer's order request can be approved based on established restrictions limiting item category, weight, size and/or value of the item(s). Following item/order approval, the NFL utility identifies a target store proximate to available couriers and having a fulfillment service capability that aligns with and/or can satisfy request parameters. In addition, the NFL utility selects an individual/courier whose expected travel itinerary enables timely delivery of the order to a buyer/recipient. Following receipt of payment to cover the costs of the items and trackable logistics services, the NFL utility purchases the item(s) from the target store(s) and arranges for the courier to receive the items. The NFL utility pays the courier for transport and delivery of the items/order to the recipient or designated mailbox.

According to one or more alternate and/or additional embodiments, a computer-implemented logistics coordination system is provided for purchasing, handling, and transporting one or more items via personal couriers to an end recipient. The system comprises: a memory storing program instructions for a personal items acquisition and transport logistics (PIATL) application; and a communication subsystem configured to communicate with a plurality of remote computing devices via one or more communication networks, the plurality of remote computing devices comprising: at least a purchaser device associated with a purchaser; and a courier device associated with a courier. The system comprises at least one processor communicatively coupled to the memory and the communication subsystem. Execution of the program instructions by the at least one processor configures the processor to cause the system to perform a series of processes including: receive, via the communication subsystem from the purchaser device, an order request for purchasing one or more items and transporting the one or more items to a recipient at a service destination; determine whether the order request is approvable based on established restrictions to fulfilling an order; identify one or more request parameters associated with fulfillment of the order request, the request parameters including at least a delivery time constraint; identify, from among a plurality of vendors, a target source having an order fulfillment capability that aligns with and is temporally feasible relative to the identified request parameters; select one or more logistics resources, including at least one courier resource, based on alignment of the one or more logistics resources with: the request parameters and the order fulfillment capability of the target source; generate a payment request covering costs associated with purchasing the one or more items, and providing logistics services to acquire, transport, and deliver the one or more items; responsive to receiving confirmation of payment, initiate purchase of the one or more items from the target source; and electronically coordinate acquisition and transportation and delivery of the one or more items via the selected one or more logistics resources in alignment with the request parameters. The at least one processor is further configured to cause the system to electronically coordinate provision of compensation to at least one of the logistics resources for facilitating one or more of the acquisition, transportation, or delivery of the one or more items to the recipient or to a designated delivery location.

According to one embodiment, the established restrictions comprising one or more of item category restrictions, legal regulations, weight limits, size limits, value thresholds, and transport eligibility criteria. According to one embodiment, to identify the target source the at least one processor is configured to cause the system to: evaluate a plurality of fulfillment service tiers associated with respective vendors, the fulfillment service tiers including tiers comprising same-day pickup, next-day pickup, third-party facilitated pickup, and expedited in-store shopping services; and select the target source based on a fulfillment service tier that satisfies the delivery time constraint.

According to one embodiment, to select the one or more logistics resources, the at least one processor is configured to cause the system to: evaluate temporal availability windows including one or more of: a store item availability time, a pickup accessibility window, a transport departure window, and a destination arrival window; and select logistics resources having availability windows that collectively satisfy the delivery time constraint.

According to one embodiment, to select the one or more logistics resources, the at least one processor is configured to cause the system to: dynamically determine a combination of the target source and at least one of a plurality of logistics services, and including at least one intermediary logistics service when required to satisfy the request parameters.

According to one embodiment, to dynamically determine the combination of logistics services, the at least one processor is configured to cause the system to: determine when a timing requirement cannot be satisfied without the third-party service; and programmatically invoke, via an application programming interface (API), a third-party service to perform at least one of in-store shopping, item pickup, or delivery to a courier resource.

According to one embodiment, to dynamically determine the combination, the at least one processor is configured to cause the system to: evaluate a probability of satisfying the delivery time constraint; and select a combination that meets or exceeds a predefined fulfillment probability threshold.

According to one embodiment, to select the one or more logistics resources, the at least one processor is configured to cause the system to apply a multi-factor optimization process that evaluates a weighted combination of factors from among a factors comprising cost to the purchaser, expected delivery speed, logistics resource availability, load distribution among courier resources, transport capacity utilization, and service quality indicators.

According to one embodiment, to select the one or more logistics resources, the at least one processor is configured to cause the system to: identify a plurality of pending approved orders associated with a common destination region; and generate an aggregated compensation package associated with transporting multiple orders to the common destination region to incentivize participation of a courier resource.

According to one embodiment, the aggregated compensation package further includes at least one travel-related incentive from among incentives comprising a travel discount, a lodging discount, a transportation rental discount, a dining benefit, or a bundled travel offer associated with participation in providing logistics services.

According to one embodiment, the courier resource comprises a registered individual traveler whose pre-scheduled travel itinerary includes travel via a transport vessel between an origination location at which the one or more desired items can be sourced and a destination region corresponding to the service destination.

According to one embodiment, the transport eligibility criteria comprise criteria associated with one or more of airline regulatory compliance requirements, customs declaration requirements, hazardous materials restrictions, prohibited goods classifications, and carrier-specific transport rules.

According to one embodiment, the order fulfillment capability of a vendor comprises at least one of inventory availability, vendor operating hours, pickup scheduling capability, in-store fulfillment staffing level, or electronic order processing capacity and shipping timeline. According to one embodiment, the logistics resources comprise one or more of a courier resource, a third-party shopping service, a local pickup agent, a warehousing intermediary, or a local delivery service.

According to one embodiment, to electronically coordinate acquisition and transportation, the at least one processor is configured to cause the system to transmit machine-readable task instructions to the courier device and receive status updates from the courier device reflecting physical progress of acquisition and transport of the one or more items.

According to one aspect of the disclosure, a method is provided for logistics coordination for purchasing, handling, and transporting one or more items via personal couriers to an end recipient. The method comprises: receiving, via a communication subsystem of an electronic system from a purchaser device, an order request for purchasing one or more items and transporting the one or more items to a recipient at a service destination; determining whether the order request is approvable based on established restrictions to fulfilling an order; identifying one or more request parameters associated with fulfillment of the order request, the request parameters including at least a delivery time constraint; identifying, from among a plurality of vendors, a target source having an order fulfillment capability that aligns with and is temporally feasible relative to the identified request parameters; selecting one or more logistics resources, including at least one courier resource, based on alignment of the one or more logistics resources with: the request parameters and the order fulfillment capability of the target source; generating a payment request covering costs associated with purchasing the one or more items, and providing logistics services to acquire, transport, and deliver the one or more items; responsive to receiving confirmation of payment, initiating purchase of the one or more items from the target source; and electronically coordinating acquisition and transportation and delivery of the one or more items via the selected one or more logistics resources in alignment with the request parameters.

According to one embodiment, the method further comprises electronically coordinating provision of compensation to at least one of the logistics resources for facilitating one or more of the acquisition, transportation, or delivery of the one or more items to the recipient or to a designated delivery location.

According to another aspect of the disclosure, a computer program product is provided. The computer program product comprises a non-transitory computer readable medium having program instructions stored thereon that when executed by a processor of a computer system configures the processor to cause the computer system to perform logistics coordination for purchasing, handling, and transporting one or more items via personal couriers to an end recipient, by implementing functions comprising: receiving, via a communication subsystem of an electronic system from a purchaser device, an order request for purchasing one or more items and transporting the one or more items to a recipient at a service destination; determining whether the order request is approvable based on established restrictions to fulfilling an order; identifying one or more request parameters associated with fulfillment of the order request, the request parameters including at least a delivery time constraint; identifying, from among a plurality of vendors, a target source having an order fulfillment capability that aligns with and is temporally feasible relative to the identified request parameters; selecting one or more logistics resources, including at least one courier resource, based on alignment of the one or more logistics resources with: the request parameters and the order fulfillment capability of the target source; generating a payment request covering costs associated with purchasing the one or more items, and providing logistics services to acquire, transport, and deliver the one or more items; responsive to receiving confirmation of payment, initiating purchase of the one or more items from the target source; and electronically coordinating acquisition and transportation and delivery of the one or more items via the selected one or more logistics resources in alignment with the request parameters.

According to one embodiment, the computer program product further comprises electronically coordinating provision of compensation to at least one of the logistics resources for facilitating one or more of the acquisition, transportation, or delivery of the one or more items to the recipient or to a designated delivery location.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal and technical equivalents.

What is claimed is:

1. A computer-implemented logistics coordination system for purchasing, handling, and transporting one or more items via personal couriers to an end recipient, the system comprising:
a memory storing program instructions for a personal items acquisition and transport logistics (PIATL) application;
a communication subsystem configured to communicate with a plurality of remote computing devices via one or more communication networks, the plurality of remote computing devices comprising: at least a purchaser device associated with a purchaser; and
a courier device associated with a courier; and
at least one processor communicatively coupled to the memory and the communication subsystem, wherein execution of the program instructions by the at least one processor configures the processor to cause the system to:
receive, via the communication subsystem from the purchaser device, an order request for purchasing one or more items and transporting the one or more items to a recipient at a service destination;
determine whether the order request is approvable based on established restrictions to fulfilling an order;
identify one or more request parameters associated with fulfillment of the order request, the request parameters including at least a delivery time constraint;
identify, from among a plurality of vendors, a target source having an order fulfillment capability that aligns with and is temporally feasible relative to the identified request parameters;
select one or more logistics resources, including at least one courier resource, based on alignment of the one or more logistics resources with: the request parameters and the order fulfillment capability of the target source;
generate a payment request covering costs associated with purchasing the one or more items, and providing logistics services to acquire, transport, and deliver the one or more items;
responsive to receiving confirmation of payment, initiate purchase of the one or more items from the target source; and
electronically coordinate acquisition and transportation and delivery of the one or more items via the selected one or more logistics resources in alignment with the request parameters.

2. The system of claim 1, wherein the at least one processor is further configured to cause the system to electronically coordinate provision of compensation to at least one of the logistics resources for facilitating one or more of the acquisition, transportation, or delivery of the one or more items to the recipient or to a designated delivery location.

3. The system of claim 1, wherein the established restrictions comprising one or more of item category restrictions, legal regulations, weight limits, size limits, value thresholds, and transport eligibility criteria.

4. The system of claim 1, wherein to identify the target source the at least one processor is configured to cause the system to:
evaluate a plurality of fulfillment service tiers associated with respective vendors, the fulfillment service tiers including tiers comprising same-day pickup, next-day pickup, third-party facilitated pickup, and expedited in-store shopping services; and
select the target source based on a fulfillment service tier that satisfies the delivery time constraint.

5. The system of claim 1, wherein to select the one or more logistics resources, the at least one processor is configured to cause the system to:
evaluate temporal availability windows including one or more of: a store item availability time, a pickup accessibility window, a transport departure window, and a destination arrival window; and
select logistics resources having availability windows that collectively satisfy the delivery time constraint.

6. The system of claim 1, wherein to select the one or more logistics resources, the at least one processor is configured to cause the system to:
dynamically determine a combination of the target source and at least one of a plurality of logistics services, and including at least one intermediary logistics service when required to satisfy the request parameters.

7. The system of claim 6, wherein to dynamically determine the combination of logistics services, the at least one processor is configured to cause the system to:
determine when a timing requirement cannot be satisfied without the third-party service; and
programmatically invoke, via an application programming interface (API), a third-party service to perform at least one of in-store shopping, item pickup, or delivery to a courier resource.

8. The system of claim 6, wherein to dynamically determine the combination, the at least one processor is configured to cause the system to:
evaluate a probability of satisfying the delivery time constraint; and
select a combination that meets or exceeds a predefined fulfillment probability threshold.

9. The system of claim 1, wherein to select the one or more logistics resources, the at least one processor is configured to cause the system to apply a multi-factor optimization process that evaluates a weighted combination of factors from among a factors comprising cost to the purchaser, expected delivery speed, logistics resource availability, load distribution among courier resources, transport capacity utilization, and service quality indicators.

10. The system of claim 1, wherein to select the one or more logistics resources, the at least one processor is configured to cause the system to:
identify a plurality of pending approved orders associated with a common destination region; and
generate an aggregated compensation package associated with transporting multiple orders to the common destination region to incentivize participation of a courier resource.

11. The system of claim 10, wherein the aggregated compensation package further includes at least one travel-related incentive from among incentives comprising a travel discount, a lodging discount, a transportation rental discount, a dining benefit, or a bundled travel offer associated with participation in providing logistics services.

12. The system of claim 1, wherein the courier resource comprises a registered individual traveler whose pre-scheduled travel itinerary includes travel via a transport vessel between an origination location at which the one or more desired items can be sourced and a destination region corresponding to the service destination.

13. The system of claim 1, wherein the transport eligibility criteria comprise criteria associated with one or more of airline regulatory compliance requirements, customs declaration requirements, hazardous materials restrictions, prohibited goods classifications, and carrier-specific transport rules.

14. The system of claim 1, wherein the order fulfillment capability of a vendor comprises at least one of inventory availability, vendor operating hours, pickup scheduling capability, in-store fulfillment staffing level, or electronic order processing capacity and shipping timeline.

15. The system of claim 1, wherein the logistics resources comprise one or more of a courier resource, a third-party shopping service, a local pickup agent, a warehousing intermediary, or a local delivery service.

16. The system of claim 1, wherein to electronically coordinate acquisition and transportation, the at least one processor is configured to cause the system to transmit machine-readable task instructions to the courier device and receive status updates from the courier device reflecting physical progress of acquisition and transport of the one or more items.

17. A method for logistics coordination for purchasing, handling, and transporting one or more items via personal couriers to an end recipient, the method comprising:
receiving, via a communication subsystem of an electronic system from a purchaser device, an order request for purchasing one or more items and transporting the one or more items to a recipient at a service destination;
determining whether the order request is approvable based on established restrictions to fulfilling an order;
identifying one or more request parameters associated with fulfillment of the order request, the request parameters including at least a delivery time constraint;
identifying, from among a plurality of vendors, a target source having an order fulfillment capability that aligns with and is temporally feasible relative to the identified request parameters;
selecting one or more logistics resources, including at least one courier resource, based on alignment of the one or more logistics resources with: the request parameters and the order fulfillment capability of the target source;
generating a payment request covering costs associated with purchasing the one or more items, and providing logistics services to acquire, transport, and deliver the one or more items;
responsive to receiving confirmation of payment, initiating purchase of the one or more items from the target source; and
electronically coordinating acquisition and transportation and delivery of the one or more items via the selected one or more logistics resources in alignment with the request parameters.

18. The method of claim 17, further comprising electronically coordinating provision of compensation to at least one of the logistics resources for facilitating one or more of the acquisition, transportation, or delivery of the one or more items to the recipient or to a designated delivery location.

19. A computer program product comprising a non-transitory computer readable medium having program instructions stored thereon that when executed by a processor of a computer system configures the processor to cause the computer system to perform logistics coordination for purchasing, handling, and transporting one or more items via personal couriers to an end recipient, by implementing functions comprising:
receiving, via a communication subsystem of an electronic system from a purchaser device, an order request for purchasing one or more items and transporting the one or more items to a recipient at a service destination;
determining whether the order request is approvable based on established restrictions to fulfilling an order;
identifying one or more request parameters associated with fulfillment of the order request, the request parameters including at least a delivery time constraint;
identifying, from among a plurality of vendors, a target source having an order fulfillment capability that aligns with and is temporally feasible relative to the identified request parameters;
selecting one or more logistics resources, including at least one courier resource, based on alignment of the one or more logistics resources with: the request parameters and the order fulfillment capability of the target source;
generating a payment request covering costs associated with purchasing the one or more items, and providing logistics services to acquire, transport, and deliver the one or more items;
responsive to receiving confirmation of payment, initiating purchase of the one or more items from the target source; and
electronically coordinating acquisition and transportation and delivery of the one or more items via the selected one or more logistics resources in alignment with the request parameters.

20. The computer program product of claim 19, further comprising electronically coordinating provision of compensation to at least one of the logistics resources for facilitating one or more of the acquisition, transportation, or delivery of the one or more items to the recipient or to a designated delivery location.
